(19) United States
(12) Patent Application Publication
(10) Pub. No.: US 2013/0069891 A1
(43) Pub. Date: Mar. 21, 2013

(54) Operation Panel with Hardware Key

(71) Applicant: Tomoji Tanaka, Toyokawa-shi (JP)

(72) Inventor: Tomoji Tanaka, Toyokawa-shi (JP)

(73) Assignee: Konica Minolta Business Technologies, Inc., Chiyoda-ku (JP)

(21) Appl. No.: 13/606,658

(22) Filed: Sep. 7, 2012

(30) Foreign Application Priority Data
Sep. 15, 2011 (JP) 2011-201573

(51) Int. Cl. G06F 3/041

(52) U.S. Cl. 345/173

(57) ABSTRACT

An operation panel includes an LCD (Liquid Crystal Display) screen, a touch panel sensor unit for accepting touch input to the LCD screen concerning operation, a hardware key, and a touch panel control microcomputer for detecting a position of touch input accepted by the touch panel sensor unit. An operation panel control unit allocates the operation accepted by the touch panel sensor unit to the hardware key when detecting a runway which is a state in which the touch panel control microcomputer cannot detect a position of touch input. Accordingly, the user's convenience can be improved.

This application is based on Japanese Patent Application No. 2011-201573 filed with the Japan Patent Office on Sep. 15, 2011, the entire content of which is hereby incorporated by reference.

### BACKGROUND OF THE INVENTION

1. Field of the Invention

The present invention relates to an operation panel, and more particularly to an operation panel including a display, a touch panel for accepting touch input to the display concerning operation, and a hardware key.

2. Description of the Related Art

A conventional general image forming apparatus such as a multifunction peripheral has an operation panel as a user interface, which includes a touch panel display as a standard output unit, and software keys and hardware keys as standard input units. The operation panel has a touch panel display for displaying a screen, a touch panel (touch pad) provided on a front surface of the touch panel display for accepting touch input from a user, and a microcomputer for touch panel control for detecting the position of touch input accepted on the touch panel.

Software keys are keys appearing on the touch panel display. The user operates the software keys by touching a prescribed region of the touch panel display. The software keys, to which prescribed functions arc allocated, are displayed in various shapes on the touch panel display and are erased (deleted) from the screen when they become unnecessary.

Hardware keys are button-shaped keys present as physical entities. The user operates the hardware keys by pressing the hardware keys. Hardware keys are generally superior to software keys in terms of viewability and operability. On the other hand, hardware keys cannot be changed in shape or deleted easily as in software keys. However, it is possible to allocate various functions to hardware keys variably in accordance with a state of the multifunction peripheral. For example, a start key is generally provided as a hardware key on the operation panel of a multifunction peripheral. Functions to execute scan, copy, and facsimile transmission, for example, are dynamically allocated in accordance with the current mode of the multifunction peripheral. The start key is generally configured as a large key far excellent in viewability and operability because it is used particularly frequently among keys in the multifunction peripheral. Hardware keys of a multifunction peripheral include a ten key pad, a stop key, etc., in addition to the start key.

During operation of the operation panel by the user, electrostatic discharge may occur to cause a microcomputer for touch panel control to run away (malfunction). This results from that electric charge on the user's finger directly escapes to the microcomputer for touch panel control and intrudes into the substrate of the microcomputer for touch panel control, or that an electromagnetic wave caused by electrostatic discharge indirectly affects the microcomputer for touch panel control. In order to eliminate the effects of electrostatic discharge, conventionally, a discharge sheet connected to a ground potential (case GND) is grounded in the vicinity of the touch panel or the hardware keys thereby to avoid direct discharge to an electrical signal line. However, this approach does not prevent the indirect effects by the electromagnetic wave.

In electrostatic-type touch panels widespread in recent years, a microcomputer for touch panel control detects a position of touch input based on a change in capacitance of the touch panel. In the electrostatic-type touch panel, it is necessary to reduce the distance between the touch panel (touch panel sensor) and the microcomputer for touch panel control as much as possible in order to reduce noise resulting from a change in capacitance at a part other than the touch panel and to obtain good detection sensitivity. For this purpose, the microcomputer for touch panel control has to be arranged close to the place where electrostatic discharge occurs. Then, the mounted microcomputer for touch panel control is extremely sensitive to electrostatic discharge.

The techniques concerning control of display operation of an operation panel in a case of trouble in an image forming apparatus are disclosed, for example, in Documents 1 to 3 below.

Document 1 discloses a technique in an image forming apparatus with a touch panel and a plurality of hardware keys, in which when failure of any one of the hardware keys is detected, an error is displayed for each function of the hardware keys to indicate that the detected hardware key is not available.

Document 2 discloses a print control apparatus, in which if an error detection mechanism detects a minor error when a renderer is expanding a bit map image based on an analysis result of a job received from each data processor, the print control apparatus allows job processing to continue while making the next job ready to be processed. The print control apparatus displays the detected error on a panel display and controls continuation or cancellation of a print process for the job in error in accordance with an instruction from panel keys.

Document 3 discloses an image processing apparatus including a user interface display unit for presenting information to a user, a user interface input unit having a hardware key for accepting input from a user, a web browser unit for allowing the user interface display unit to display a display screen based on page data obtained from a web server, a hardware key function allocation unit for determining a function to be allocated to the hardware key based on the page data, and a hardware key control unit for controlling the hardware key in accordance with the determination of allocation of the function to the hardware key by the hardware key function allocation unit.
Document 1: Japanese Laid-Open Patent Publication No. 2010-111044
Document 2: Japanese Laid-Open Patent Publication No. 2002-248840
Document 3: Japanese Laid-Open Patent Publication No. 2010-146078

When the microcomputer for touch panel control runs away, the microcomputer for touch panel control cannot detect the position of the user's touch input on the touch panel. Therefore, conventionally, the user (operator) who does input to the operation panel cannot continue input to the operation panel. Therefore, the conventional operation panel is inconvenient for users.

In the techniques disclosed in Documents 1 and 2, an unavailable trouble state is indicated to the user, or continuation or cancellation of a print process for a job is controlled through operation on the touch panel. However, those techniques do not pay attention to runaway of a microcomputer for touch panel control. Therefore, in these techniques, when the microcomputer for touch panel control runs away, input to the operation panel cannot be continued (inoperable state).

In the technique disclosed in Document 3, the function key of the browser screen based on page data can be allocated to the hardware key during display by the web browser. However, this technique does not pay attention to runaway of the microcomputer for touch panel control. For example, in a case where a confidential fax is being received or there exists data already received, when the microcomputer for touch panel control runs away, the user cannot make subsequent operations with the software key in the touch panel and therefore cannot open the received confidential fax or print out the received data. On the other hand, in a case where there exists a reserved job to be subjected to printout, when the microcomputer for touch panel control runs away, the user wants to delete the job but cannot delete the job in order to prevent unnecessary printout. As a result, unnecessary printout is executed.

It may be possible to allocate keys corresponding to software keys to hardware keys at all times. However, this approach requires that all operation inputs accepted by software keys should be allocated to hardware keys. As a result, an enormous number of hardware keys have to be provided on the operation panel, which is not realistic.

### SUMMARY OF THE INVENTION

An object of the present invention is to provide an operation panel with improved convenience for users.

An operation panel according to an aspect of the present invention includes a display unit, a touch panel for accepting touch input to the display unit concerning operation, a hardware key, a touch panel control unit for detecting a position of touch input accepted by the touch panel, a runaway detection unit for detecting a runaway which is a state in which the touch panel control unit cannot detect a position of touch input, and an allocation unit for allocating operation accepted by the touch panel to the hardware key when a runaway is detected by the runaway detection unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically showing a configuration of a tandem-type digital color multifunction peripheral (MFP) as an image forming apparatus in a first embodiment of the present invention.

FIG. 2 is a cross-sectional view for explaining an engine unit of the digital color MFP in detail.

FIG. 3 is a block diagram showing a control configuration of the digital color MFP in the first embodiment of the present invention.

FIG. 4 is a block diagram showing a configuration of an operation panel 100.

FIG. 5 is a plan view showing a configuration of operation panel 100 in a state in which a list of jobs (active job list) registered in the digital color MFP appears on an LCD screen 101.

FIG. 6 is a diagram schematically showing screen display of operation panel 100 in a case where a touch panel control microcomputer 103 runs away in a state in which the list of jobs registered in the digital color MFP appears on LCD screen 101.

FIG. 7 is a diagram schematically showing a state in which a reception list of confidential faxes appears on LCD screen 101.

FIG. 8 is a diagram schematically showing screen display of operation panel 100 in a case where touch panel control microcomputer 103 runs away in a state in which the reception list of confidential faxes appears on LCD screen 101.

FIG. 9 is a flowchart of control performed by an operation panel control unit 156 in the first embodiment of the present invention.

FIG. 10 is a diagram showing a state in which a screen showing a copy job in progress appears on LCD screen 101.

FIG. 11 is a diagram schematically showing screen display of operation panel 100 in the case where touch panel control microcomputer 103 runs away in a state in which the screen showing a copy job in progress appears on LCD screen 101.

FIG. 12 is a flowchart of control performed by operation panel control unit 156 in a second embodiment of the present invention.

### DESCRIPTION OF THE PREFERRED EMBODIMENTS

Embodiments of the present invention will be described below based on the figures.

In the following embodiments, it is assumed that an operation panel is used to operate an image forming apparatus. The image forming apparatus forms an image, for example, by an electrophotographic or electrostatic recording method. Examples of the image forming apparatus include an MFP (Multi-Function Peripheral) having scanner, facsimile, copy, printer, data communication, and server functions, a facsimile machine, a printer, and the like. The image forming apparatus may form an image by an ink-jet method. The operation panel may be any of those that control devices including, for example, home appliances and audio/video devices, in addition to image forming apparatuses.

The image forming apparatus in the following embodiments has an operation panel configured to include a screen (display unit) such as an LCD (Liquid Crystal Display) screen for displaying operational information, a touch panel arranged on the front surface thereof, and hardware keys (external keys). The operation panel is to perform operation to operate equipment. When an operation panel control unit detects a runaway of a microcomputer for touch panel control (touch panel control microcomputer) (CPU for touch panel), in particular, in a case of screen display that requires urgent operation, the operation panel automatically allocates an operation key for executing the subsequent operation, which is essentially operated by a software key in the touch panel, to a predetermined hardware key in the vicinity of the LCD screen. In addition, the operation panel displays guidance on the LCD screen to indicate that the hardware key is available for operation, and notifies the operator with beep sound. Accordingly, the user who requires urgent operation can operate the image forming apparatus with the execution key allocated to the hardware key, without confusion.

### First Embodiment

First of all, a configuration of the image forming apparatus in the present embodiment will be described.

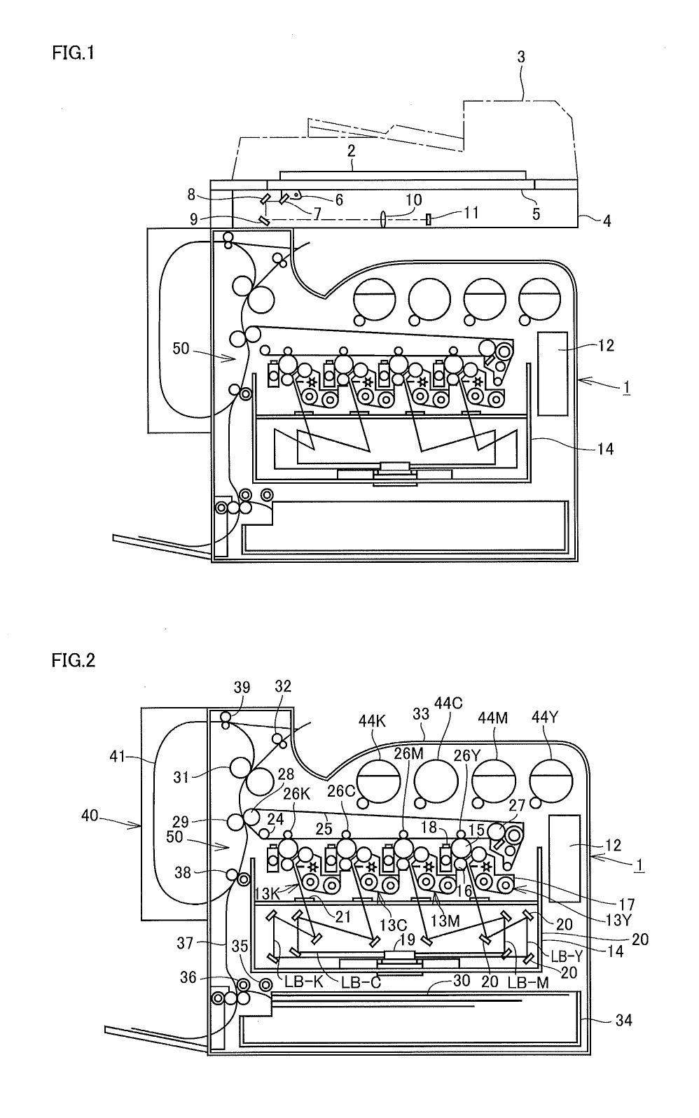

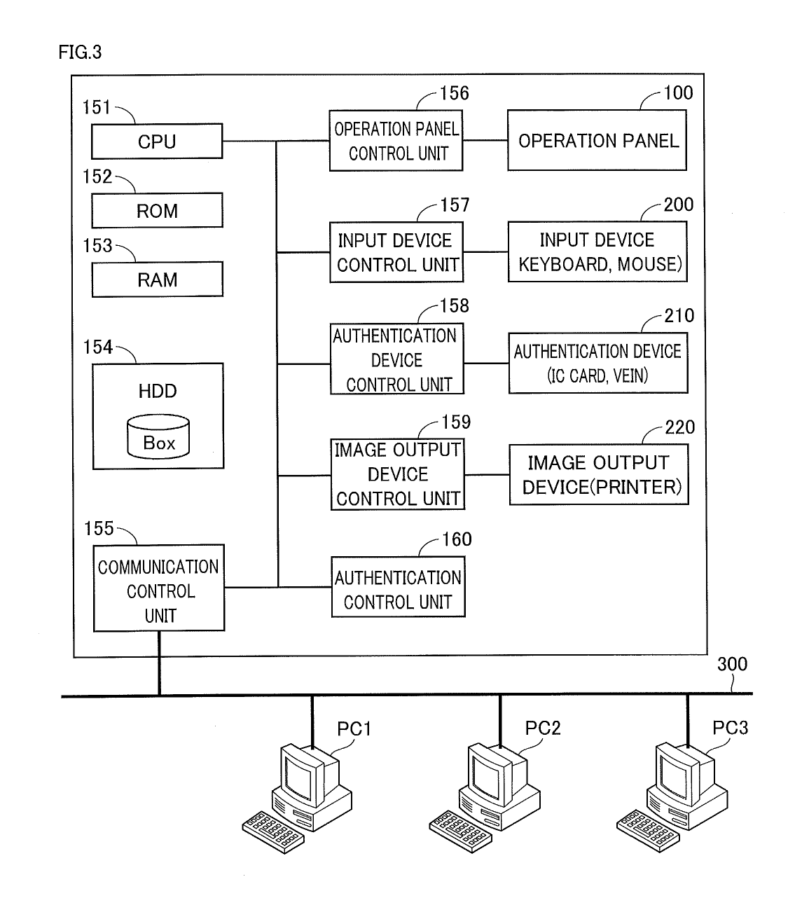

Referring to FIG. 1 and FIG. 2, a digital color MFP in the embodiment of the present invention is an apparatus called a digital multifunction peripheral. The digital color MFP has functions for executing a scan job of accumulating a scanned image of a set original into an HDD (Hard Disk Drive) or the like, a copy job of printing the image accumulated in the scan job on paper, a print job of making a print on paper based on a print instruction received from an external terminal such as a PC (Personal Computer), a facsimile job of accumulating facsimile data received from a fax machine or the like into the HDD, and a job of printing an image accumulated in the HDD or the like on paper.

The digital color MFP includes a main unit 1 of the digital color MFP, an ADF (Automatic Document Feeder) 3 provided above main unit 1, and an image scanner 4 provided between main unit 1 and ADF 3. ADF 3 automatically conveys originals 2 one by one in a separated state. Image scanner 4 scans an image of original 2 conveyed by ADF 3.

Image scanner 4 includes a platen glass 5 on which original 2 is placed, a light source 6 for illuminating original 2, a full rate mirror 7 and half rate mirrors 8 and 9 for reflecting a reflection light image from original 2, an imaging lens 10 for imaging reflection light from original 2, and an image scanner element 11, for example, formed of a CCD (Charge Coupled Device).

When original 2 is placed on platen glass 5, light source 6 illuminates original 2. The reflection light image from original 2 (colorant reflection light image) is scan-exposed on image scanner element 11 through reduction optics including full rate mirror 7, half rate mirrors 8 and 9, and imaging lens 10. Image scanner clement 11 scans a reflection light image of original 2 at a prescribed dot density (for example, 16 dots/mm).

Image scanner 4 has original-scanning functions as an MFP, including scan of a faxed original, and direct transmission of scanned data by email and direct saving in a box (Scan to Email/Box).

The colorant reflection light image of original 2 scanned by image scanner 4 is sent as three-color original reflectivity data of red (R), green (G), and blue (B), each having an eight-bit size, to an image processing unit 12 of main unit 1.

Main unit 1 includes image processing unit 12, image forming units 13Y, 13M, 13C, and 13K, an intermediate transfer belt 25, a secondary transfer roll 29, a fixing unit 31, and a conveyance unit 50.

Image processing unit 12 performs prescribed image processing including shading correction, displacement correction, brightness/color space conversion, gamma correction, border erasure, and color/movement edition, on the reflectivity data of original 2. Image processing unit 12 also performs prescribed image processing on image data sent from an external terminal or the like.

Image data subjected to prescribed image processing in image processing unit 12 is converted by image processing unit 12 into original reproduction colorant tone data of Y, M, C, and K, each having an eight-bit size, which are sent to a print head unit 14 of image forming units 13Y, 13M, 13C, and 13K of yellow (Y), magenta (M), cyan (C), and black (K), respectively.

Image forming units 13Y, 13M, 13C, and 13K are arranged in parallel at prescribed intervals in the horizontal direction. These four image forming units 13Y, 13M, 13C, and 13K have the same configuration. Each of image forming units 13Y, 13M, 13C, and 13K mainly has a photoconductor drum 15 serving as an image carrier rotatably driven at a prescribed speed, a primary charge roller 16 for uniformly charging the surface of photoconductor drum 15, print head unit 14 serving as an image exposure device for exposing an image corresponding to a prescribed color on the surface of photoconductor drum 15 to form an electrostatic latent image, a developing unit 17 for developing the electrostatic latent image formed on photoconductor drum 15 with toner of a prescribed color, and a cleaner 18 for cleaning the surface of photoconductor drum 15.

Print head unit 14 is configured to be shared between four image forming units 13Y, 13M, 13C, and 13K. Print head unit 14 is configured to modulate not-shown four semiconductor lasers according to the original reproduction colorant tone data of each color to emit laser beams LB-Y, LB-M, LB-C, and LB-K from these semiconductor lasers according to the tone data. Print head unit 14 may be configured individually for each of a plurality of image forming units. Print head unit 14 includes a rotating polygon mirror 19, reflecting mirrors 20, and windows 21.

Laser beams LB-Y, LB-M, LB-C, and LB-K emitted from the four semiconductor lasers of print head unit 14 are applied to one rotating polygon mirror 19 and deflected by rotating polygon mirror 19. In this case, laser beams LB-Y and LB-M are applied to one side surface of rotating polygon mirror 19 while laser beams LB-C and LB-K are applied to the opposite side surface of rotating polygon mirror 19. As a result, the direction in which laser beams LB-Y and LB-M are deflected by rotating polygon mirror 19 is opposite to the direction in which laser beams LB-C and LB-K are deflected. Laser beams LB-Y, LB-M, LB-C, and LB-K deflected by rotating polygon mirror 19 are reflected by a plurality of reflecting mirrors 20 through a not-shown f-θ lens and scan-exposed on photoconductor drums 15 of the respective image forming units diagonally from below through windows 21.

Laser beams LB-Y, LB-M, LB-C, and LB-K form electrostatic latent images on the surfaces of photoconductor drums 15. The direction in which laser beams LB-Y and LB-M are scan-exposed on photoconductor drums 15 is opposite to the direction in which laser beams LB-C and LB-K are scanned and exposed. The electrostatic latent images formed on photoconductor drums 15 are developed by developing unit 17 with colors of Y, M, C, and K. The toner images formed on photoconductor drums 15 are transferred by primary transfer rolls 26Y, 26M, 26C, and 26K onto intermediate transfer belt 25 arranged above photoconductor drums 15. Accordingly, toner images of Y, M, C, and K are superimposed on intermediate transfer belt 25. After primary transfer, toner left on the surface of photoconductor drum 15 is removed by cleaner 18.

Intermediate transfer belt 25 is suspended around a drive roll 27, a backup roll 28, and a tension roll 24 under a prescribed tension. Drive roll 27 is rotatably driven by a not-shown dedicated drive motor excellent in constant-speed performance and is driven to circulate in a prescribed direction at a prescribed speed. Intermediate transfer belt 25 is formed, for example, by forming a flexible film of synthetic resin such as polyimide in a strip shape and connecting both ends of the strip-shaped synthetic resin film to form an endless belt.

Conveyance unit 50 includes a paper-feed roll 35, a roll pair 36, a resist roll 38, an output roll 32, and a roll pair 39.

Transfer paper 30 of a prescribed size is supplied from a paper-feed cassette 34 by paper-feed roll 35 and roll pair 36 for separately conveying paper. The supplied transfer paper 30 is once conveyed to resist roll 38 through a paper conveyance path 37 and stopped. Then, transfer paper 30 is sent to a secondary transfer position of intermediate transfer belt 25 by resist roll 38 rotating at a prescribed timing.

Secondary transfer roll 29 is positioned on the side of backup roll 28. The toner image on intermediate transfer belt 25 is secondary-transferred onto transfer paper 30 as a transfer material, using pressing force and electrostatic force by secondary transfer roll 29 in pressure-contact with backup roll 28. Transfer paper 30 having the toner image transferred thereon is conveyed to fixing unit 31 positioned above.

Transfer paper 30 having the toner image transferred thereon is subjected to a toner image fixing process using heat and pressure by fixing unit 31 and thereafter output by output roll 32 onto an output tray 33 provided above main unit 1.

For example, in a case where a full-color duplex copy is produced in the digital color MFP, transfer paper 30 having an image fixed on the front surface thereof is not output by output roll 32 onto output tray 33 but is conveyed to a duplex conveyance unit 40 through paper conveyance roll pair 39 with its conveyance direction changed by a not-shown switch gate. Duplex conveyance unit 40 reverses the front and the back of transfer paper 30 using a not-shown conveyance roll pair provided along paper conveyance path 41. The reversed transfer paper 30 is conveyed to resist roll 38 again. Thereafter, an image is transferred and fixed on the back side of transfer paper 30, which is then output onto output tray 33.

Toner cartridges 44Y, 44M, 44C, and 44K for supplying toner to developing units 17 of Y, M, C, and K are provided above intermediate transfer belt 25.

FIG. 3 is a block diagram showing a control configuration of the digital color MFP in the first embodiment of the present invention.

Referring to FIG. 3, the digital color MFP includes an operation panel 100, an input device 200, an authentication device 210, and an image output device 220. Operation panel 100 mainly includes, for example, a display device such as an LCD, a touch panel, and a hardware key. The detailed configuration of operation panel 100 will be described later. Input device 200 is configured to include, for example, a not-shown keyboard, mouse, etc. Authentication device 210 is configured with, for example, a contact-type or non-contact type IC (Integrated Circuit) card authentication device, or a finger vein authentication device. Image output device 220 has a printer output function.

The digital color MFP further includes a CPU (Central Processing Unit) 151, a ROM (Read Only Memory) 152, a RAM (Random Access Memory) 153, an HDD 154, a communication control unit 155, an operation panel control unit 156, an input device control unit 157, an authentication device control unit 158, an image output device control unit 159, and an authentication control unit 160. ROM 152, RAM 153, HDD 154, communication control unit 155, operation panel control unit 156, input device control unit 157, authentication device control unit 158, image output device control unit 159, and authentication control unit 160 are connected to a bus of CPU 151.

CPU 151 centrally controls the entire operation of the digital color MFP. ROM 152 is a memory in which an operating program of CPU 151 is stored. RAM 153 is a memory that provides a working area when CPU 151 operates. HDD 154 is used to temporarily store data of a copy image or data of an image transmitted from a print instruction terminal (external terminals PC1 to PC3), or to save data of the scanned image into a box. Communication control unit 155 controls communication between the digital color MFP and each of external terminals PC1 to PC3 connected to each other via a network 300. Operation panel control unit 156, input device control unit 157, authentication device control unit 158, and image output device control unit 159 control operation panel 100, input device 200, authentication device 210, and image output device 220, respectively. Authentication control unit 160 controls security authentication of the digital color MFP as a whole.

Network 300 is a wired or wireless LAN (Local Area Network). Network 300 is connected using a protocol such as TCP/IP (Transmission Control Protocol/Internet Protocol). Equipment connected to network 300 can mutually exchange various data. Equipment may be connected using a wide area network such as the Internet or a dedicated line instead of network 300.

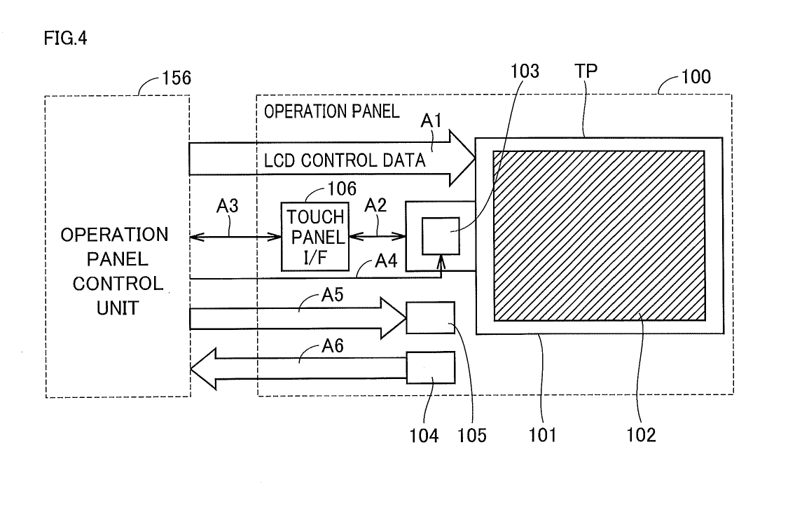

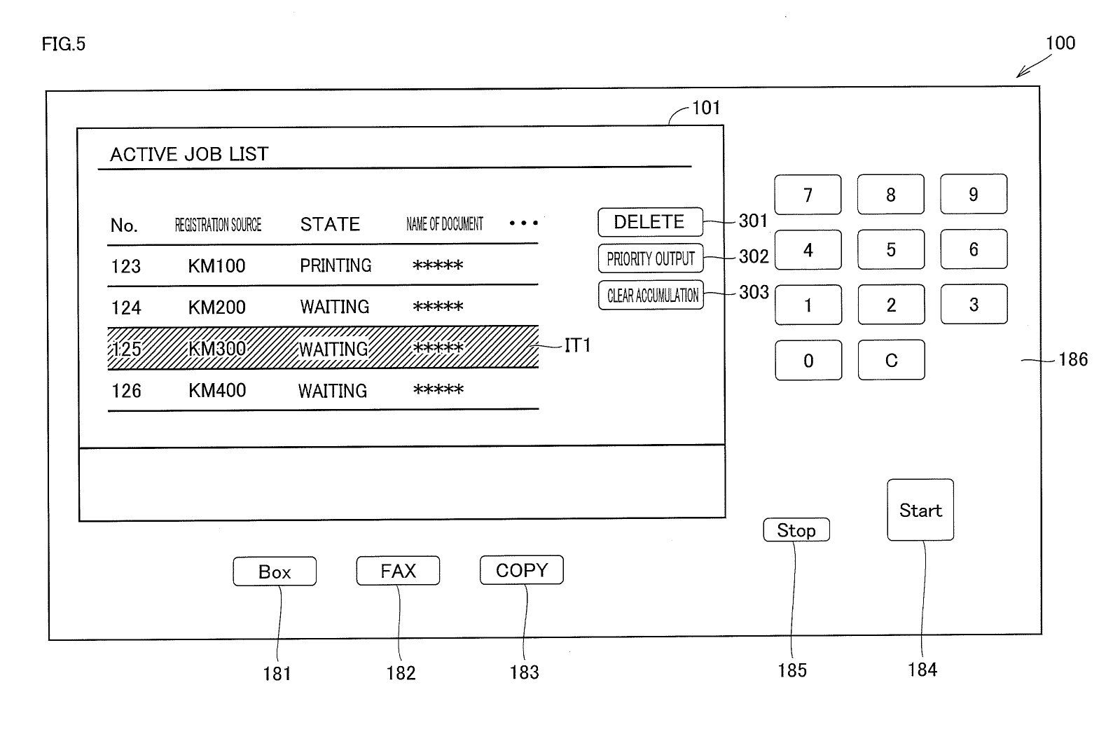

FIG. 4 is a block diagram showing a configuration of operation panel 100.

Referring to FIG. 4, operation panel 100 includes an LCD (Liquid Crystal Display) screen 101 (an exemplary display unit), a touch panel TP, a hardware key 104, an alert LED or buzzer 105, and a touch panel IF (interface) 106. Operation panel 100 may further include a not-shown display LED. LCD screen 101, touch panel TP, hardware key 104, and alert LED or buzzer 105 are each connected to operation panel control unit 156.

Operation panel control unit 156 may be contained in operation panel 100 or may be provided outside operation panel 100. CPU 151 may serve the function of operation panel control unit 156.

Touch panel TP is configured to include a touch panel sensor unit 102 (an exemplary touch panel) and a touch panel control microcomputer 103 (an exemplary touch panel control unit). Touch panel control microcomputer 103 is mounted on, for example, an FPC (Flexible Printed Circuit). Touch panel TP is preferably formed in a module in which touch panel sensor unit 102 and the FPC having touch panel control microcomputer 103 mounted thereon are integrated. In the case where the touch panel TP is formed in a module, touch panel control microcomputer 103 is very close to the user's operating region. Therefore, it is more likely that touch panel control microcomputer 103 runs away due to the effect of electrostatic discharge that occurs during touch panel operation by the user. A runaway of touch panel control microcomputer 103 means a state in which touch panel control microcomputer 103 cannot detect a position of touch input.

LCD screen 101 is to operate the digital color MFP and display various information.

Touch panel sensor unit 102 is arranged, for example, on the front surface of LCD screen 101. Touch panel sensor 102 accepts touch input (equipment operating input) to LCD screen 101 concerning operation of the digital color MFP.

Touch panel control microcomputer (CPU for touch panel control) 103 is arranged in the vicinity of touch panel sensor unit 102 and detects the position of touch input accepted by touch panel sensor unit 102 (coordinate detection control). Preferably, touch panel control microcomputer 103 senses the position of touch input by an electrostatic capacitive method. However, any other method such as a resistive film method, a surface acoustic wave method, an infrared ray method, or an electromagnetic induction method may be used for position detection.

Hardware key 104 is arranged around touch panel TP to accept input related to operation of the digital color MFP.

Alert LED or buzzer 105 gives a notification to the user with LED alert display or beep sound in a prescribed case. Alert LED or buzzer 105 may give an alert using at least one of light and sound.

Operation panel control unit 156 performs drive control of LCD screen 101, control of touch panel TP, control of hardware key 104 (allocation of functions), detection of runaway of touch panel control microcomputer 103, and control of display or beep sound by alert LED or buzzer 105.

Specifically, operation panel control unit 156 transmits LCD control data to touch panel TP as shown by an arrow A1 to control a display state of LCD screen 101. The FW (firmware) of touch panel control microcomputer 103 outputs a microcomputer output signal indicating an operating state of touch panel control microcomputer 103 to touch panel IF 106 as shown by an arrow A2. Touch panel IF 106 monitors the microcomputer output signal and identifies whether touch panel control microcomputer 103 is in a runaway state or not. When touch panel IF 106 identifies that touch panel control microcomputer 103 is in a runaway state, touch panel IF 106 notifies operation panel control unit 156 of the runaway of touch panel control microcomputer 103 as shown by an arrow A3. When the runaway of touch panel control microcomputer 103 is sensed, operation panel control unit 156 executes a reset process and an initialization process of touch panel control microcomputer 103 by setting a hardware reset signal active to be sent to the touch panel control microcomputer, as shown by an arrow A4. Accordingly, touch panel control microcomputer 103 automatically recovers from the runaway state. Operation panel control unit 156 allows alert LED or buzzer 105 to produce LED alert display or beep sound in a prescribed case, as shown by an arrow A5. Operation panel control unit 156 receives information about the input accepted by hardware key 104, as shown by an arrow A6.

The reset process of touch panel control microcomputer 103 means a process of returning touch panel control microcomputer 103 to a startup state. The initialization process of touch panel control microcomputer 103 means a process of making an initial adjustment of touch panel sensor unit 102 (calibration).

The operation of operation panel 100 in the present embodiment will now be described.

FIG. 5 is a plan view showing a configuration of operation panel 100 in a state in which a list of jobs registered in the digital color MFP appears on LCD screen 101.

Referring to FIG. 5, operation panel 100 mainly includes LCD screen 101, a key 181 as a box key, a key 182 as a fax key, a key 183 as a copy key, a key 184 as a start key, a key 185 as a stop key, and a key 186 as a ten key pad.

Key 181 is pressed for transition to a screen related to a job of saving a file scanned by the scanner or a file transmitted from an external terminal into a box of HDD 154. Key 182 is pressed for transition to a screen related to a job of sending a fax from the digital color MFP to an external terminal. Key 183 is pressed for transition to a screen related to a copy job. Key 184 is pressed to execute a variety of jobs. Key 185 is pressed to stop a job in progress. Key 186 is a key to accept input of numbers. Keys 181 to 186 are examples of hardware key 104.

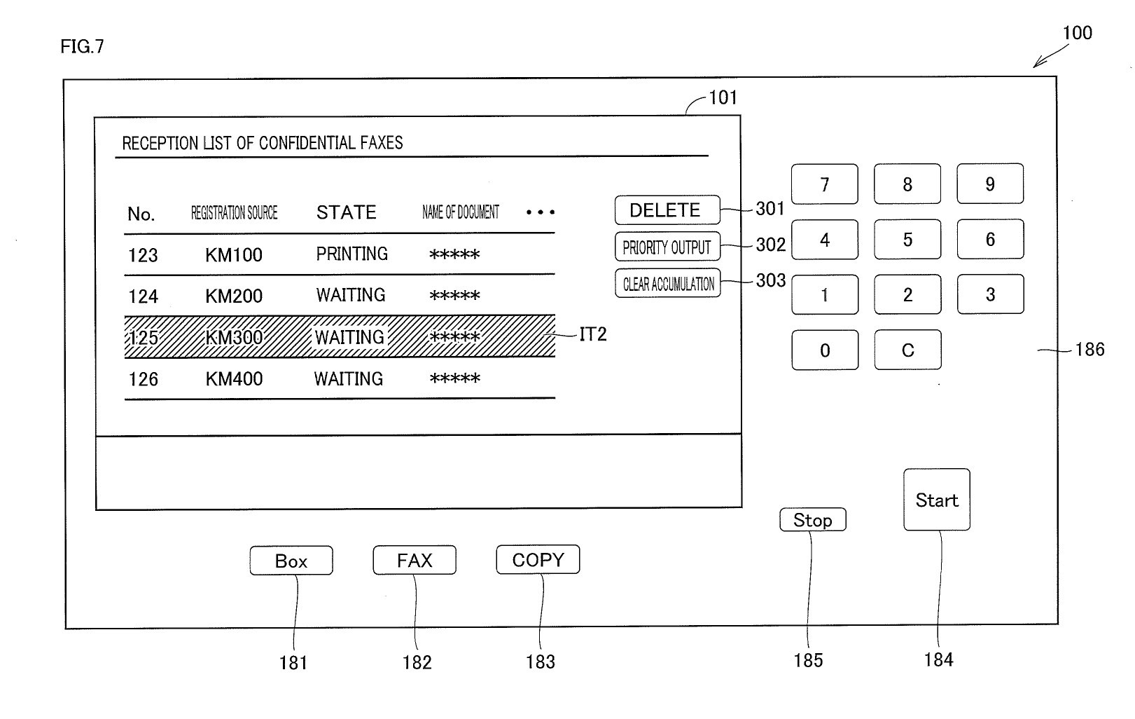

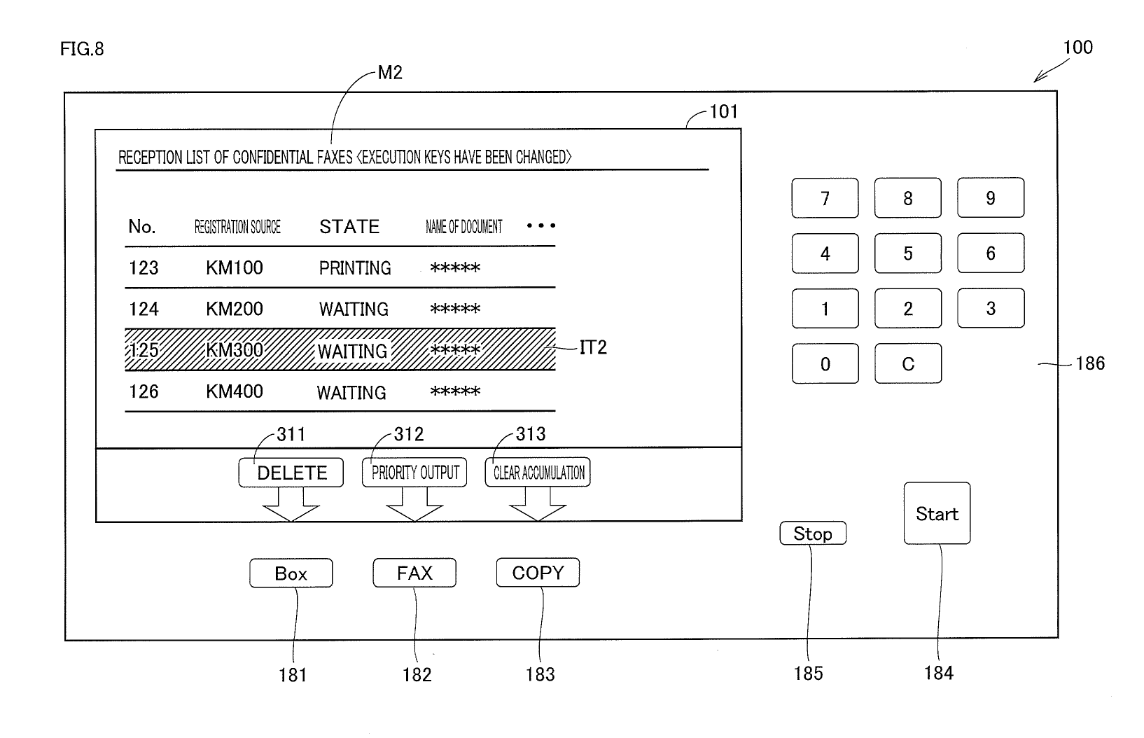

In FIG. 5, a list of jobs (active job list) already registered in the digital color MFP appears on LCD screen 101. In the following, the screens shown in FIG. 5 and FIG. 7 are also called an urgent operation screen. The screen in FIG. 5 appears when a prescribed software key displayed on LCD screen 101 on standby is pressed.

In the job list, “number,” “registration source,” “status, ” and “document name” fields are provided to indicate information of each job. Any other information of a job may be indicated. In the “number” field, a number given in order of registration is displayed. In the “registration source” field, identification information (for example, ID (identification)) of a user who registers that job is displayed. In the “status” field, an execution state of the job (in progress or waiting) is displayed. In the “document name” field, the name of a document or data to be used for the job is displayed.

Of four jobs registered in the job list, a job No. 123 is now being executed (printing) and erased from the job list at the end of execution. Other three jobs are waiting in a state in which they are accumulated in the digital color MFP. In addition to the job list, keys (icons) 301 to 303 for performing operations of “delete,” “priority output,” and “clear accumulation,” respectively, are displayed on LCD screen 101.

For example, when a key IT1 labeled a job No. 125 is pressed, the color of key IT1 changes to indicate a state in which the job No. 125 is selected. When “delete” key 301 is pressed in the state in which the job No. 125 is selected, the job No. 125 is erased from the job list. When “priority output” key 302 is pressed, the job No. 125 is executed preceding other job in progress. When “clear accumulation” key 303 is pressed, the job No. 125 is executed when the job No. 125 becomes ready to be executed (after execution of other job is finished). Keys IT1 and 301 to 303 all are software keys. In other words, these keys are keys displayed on LCD screen 101, and operation panel 100 detects that these keys are pressed, by detecting touch input to LCD screen 101 on touch panel TP.

If touch panel control microcomputer 103 runs away in the state in which the job list appears on LCD screen 101, the display state of LCD screen 101 is not changed, while touch panel control microcomputer 103 becomes unable to detect the position of touch input. Therefore, the user cannot perform operation using the software key when urgent operation such as deletion, priority output, or accumulation clearance of a job is necessary. When touch panel control microcomputer 103 runs away, the user cannot use the software keys for a considerable period of time until the reset process and the initialization process of touch panel control microcomputer 103 are completed.

Therefore, touch panel TP becomes unresponsive when urgent operation is necessary, thereby disabling operation by the user. As a result, unnecessary printout of the job that the user wants to delete is continued, or the job that the user wants to output by priority is not executed until printout of a job registered prior to that job is finished, thereby making the user to wait for a long time.

In order to prevent such a situation, in the present embodiment, when a runaway of touch panel control microcomputer 103 is detected, operation panel control unit 156 allocates, to hardware key 104, the operation accepted by the software key on LCD screen 101 (touch panel TP) at the time of detection of the runaway (an operation key to execute the next operation).

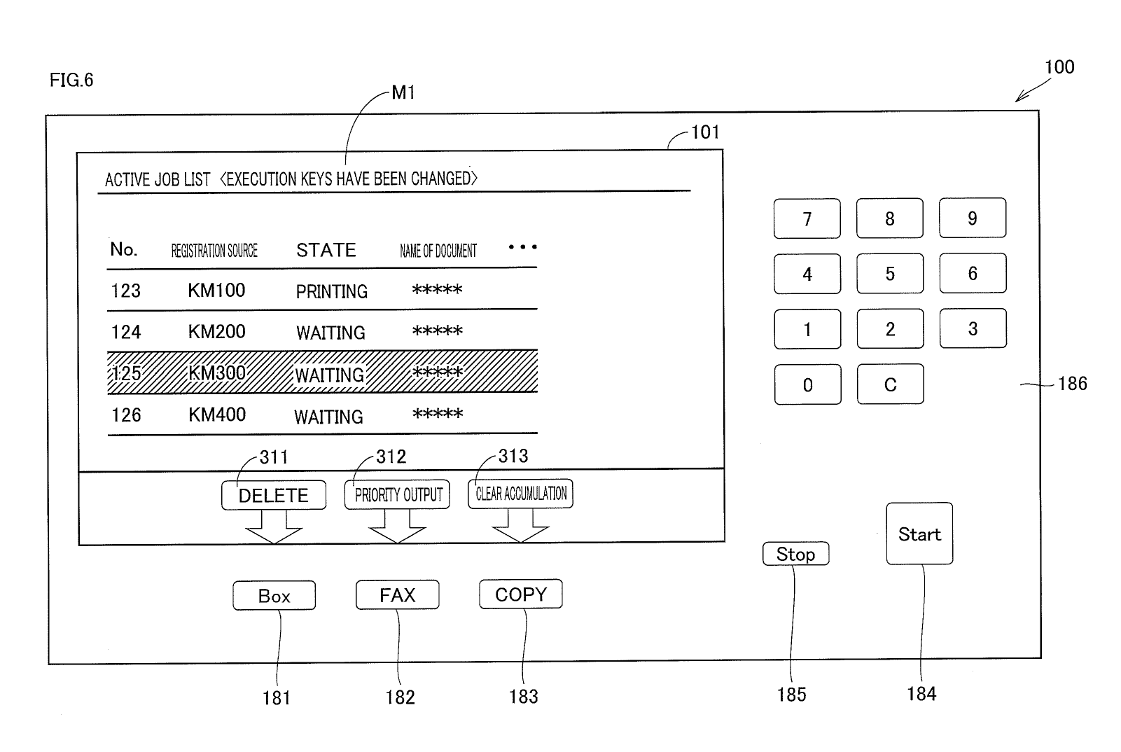

FIG. 6 is a diagram schematically showing screen display of operation panel 100 in a case where touch panel control microcomputer 103 runs away in a state in which the list of jobs registered in the digital color MFP appears on LCD screen 101.

Referring to FIG. 6, in a case where a runaway of touch panel control microcomputer 103 is detected in a state in which touch panel TP is accepting touch input related to the next operation (the next operation waiting state with touch panel TP), operation panel control unit 156 allocates a key for performing the next operation to hardware key 104 in the vicinity of LCD screen 101 and makes guidance display on LCD screen 101 to indicate that the next operation can be performed with hardware key 104 (display to indicate operation allocated to hardware key 104).

Specifically, the respective functions of keys 301 to 303 for performing operations of “delete,” “priority output,” and “clear accumulation” are allocated to keys 181 to 183 below LCD screen 101 in the vicinity thereof. The function of “delete” key 301 is allocated to key 181, the function of “priority output” key 302 is allocated to key 182, and the function of “clear accumulation” key 303 is allocated to key 183.

Display 311 to 313 is performed on LCD screen 101 to indicate that the respective functions of keys 301 to 303 are allocated to keys 181 to 183, respectively. Display 311 gives a notification that the function of “delete” key 301 is allocated to key 181. Display 312 gives a notification that the function of “priority output” key 302 is allocated to key 182. Display 313 gives a notification that the function of “clear accumulation” key 303 is allocated to key 183. Display 311 to 313 does not accept being pressed by the user per se.

Keys 301 to 303 for performing operations of “delete,” “priority output,” and “clear accumulation,” respectively, for the selected job, which were displayed on the job list display screen (FIG. 5) before the runaway of touch panel control microcomputer 103, are deleted from LCD screen 101. For example, a message M1 “execution key is now changed” appears on LCD screen 101 to notify the user of the change from the software key to hardware key 104.

After the reset process and the initialization process of touch panel control microcomputer 103 are completed and operation with touch panel TP becomes possible, operation panel control unit 156 terminates the allocation of operations to hardware key 104 and performs a process for returning the display on LCD screen 101 to the job list display screen (FIG. 5, normal display screen).

In a case where operation panel control unit 156 detects a runaway of touch panel control microcomputer 103 and allocates operation to hardware key 104 (when the screen in FIG. 5 is switched to the one in FIG. 6), operation panel control unit 156 may allow alert LED or buzzer 105 to produce LED alert display or beep sound. When the allocation of operation to hardware key 104 is terminated (the screen in FIG. 6 is switched to the one in FIG. 5), operation panel control unit 156 may allow alert LED or buzzer 105 to produce LED alert display or beep sound.

In a case other than the foregoing case, when touch panel control microcomputer 103 runs away in a state in which a confidential fax is being received or in a state in which a reception list that is a list of received jobs for confidential faxes appears on LCD screen 101, operation panel control unit 156 may allocate, for example, a confidential job print instruction key or a job discard key to hardware key 104.

FIG. 7 is a diagram schematically showing a state in which a reception list of confidential faxes appears on LCD screen 101. The screen in FIG. 7 appears, for example, when a prescribed software key displayed on LCD screen 101 on standby is pressed.

In the reception list, “number,” “registration source,” “status,” and “document name” fields are provided to indicate information of the received job. Any other information of the received job may be indicated. In the “number” field, a number given in order in which the digital color MFP starts receiving is displayed. In the “registration source” field, identification information (for example, ID) of the user who sends the received job is displayed. In the “status” field, the execution state (printing or waiting) of the received job is displayed. In the “document name” field, the name of the received document or data is displayed.

Of four received jobs registered in the reception list, a job No. 123 is now being executed (printing) and erased from the reception list at the end of execution. Other three jobs are waiting in a state in which the received data thereof is accumulated in HDD 154. In addition to the reception list, keys (icons) 301 to 303 for performing operations of “delete,” “priority output,” and “clear accumulation” are displayed in LCD screen 101.

For example, when a key IT2 labeled a job No. 125 is pressed, the color of key IT2 changes to indicate that the job No. 125 is selected. When “delete” key 301 is pressed in the state in which the job No. 125 is selected, the job No. 125 is erased from the reception list, and the received data thereof is deleted from HDD 154. When “priority output” key 302 is pressed, the job No. 125 is executed (printed or output) preceding other job in progress. When “clear accumulation” key 303 is pressed, the job No. 125 is executed when the job No. 125 becomes ready to be executed (after execution of other job is finished). Keys IT2 and 301 to 303 are all software keys.

In at least one of the cases where a received job of a confidential fax is being executed, where there exists data already received in a received job of a confidential fax, and where there exists a reserved received job of a confidential fax, when a runaway of touch panel control microcomputer 103 is detected, operation panel control unit 156 allocates, to hardware key 104, the functions of keys 302 and 303 for giving an instruction to output the received data of the received job and the function of key 301 for giving an instruction to discard the received job, which have been accepted by software keys on LCD screen 101 (touch panel TP).

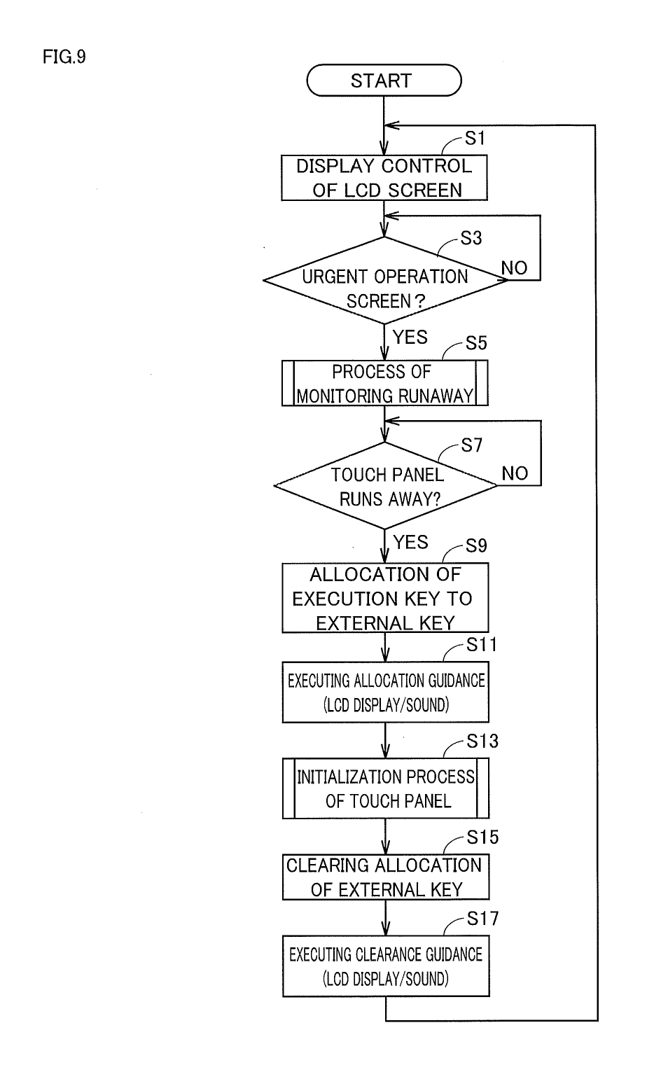

FIG. 8 is a diagram schematically showing screen display of operation panel 100 in the case where touch panel control microcomputer 103 runs away in a state in which the reception list of confidential faxes appears on LCD screen 101.

Referring to FIG. 8, specifically, the respective functions of keys 301 to 303 are allocated to keys 181 to 183 below LCD screen 101 in the vicinity thereof. The function of “delete” key 301 is allocated to key 181, the function of “priority output” key 302 is allocated to key 182, and the function of “clear accumulation” key 303 is allocated to key 183.

Display 311 to 313 is performed on LCD screen 101 to indicate that the respective functions of keys 301 to 303 are allocated to keys 181 to 183, respectively. Display 311 gives a notification that the function of “delete” key 301 is allocated to key 181. Display 312 gives a notification that the function of “priority output” key 302 is allocated to key 182. Display 313 gives a notification that the function of “clear accumulation” key 303 is allocated to key 183. Display 311 to 313 does not accept being pressed by the user per se.

Keys 301 to 303 for performing operations of “delete,” “priority output,” and “clear accumulation,” respectively, for the selected fax, which have been displayed on the reception list display screen (FIG. 7), are deleted from LCD screen 101. For example, a message M2 “execution key is now changed” appears on LCD screen 101 to notify the user of the change from the software key to hardware key 104.

After the reset process and the initialization process of touch panel control microcomputer 103 are completed and operation with touch panel TP becomes possible, operation panel control unit 156 terminates the allocation of operations to hardware key 104 and performs a process for returning the display on LCD screen 101 to the reception list display screen (FIG. 7, normal display screen).

In a case where operation panel control unit 156 detects a runaway of touch panel control microcomputer 103 and allocates operation to hardware key 104 (when the screen in FIG. 7 is switched to the one in FIG. 8), operation panel control unit 156 may allow alert LED or buzzer 105 to produce LED alert display or beep sound. When the allocation of operation to hardware key 104 is terminated (the screen in FIG. 8 is switched to the one in FIG. 7), operation panel control unit 156 may allow alert LED or buzzer 105 to produce LED alert display or beep sound.

FIG. 9 is a flowchart of control performed by operation panel control unit 156 in the first embodiment of the present invention.

Referring to FIG. 9, operation panel control unit 156 starts display control of LCD screen 101 (S1) and determines whether display on LCD screen 101 changes to a predetermined urgent operation screen (for example, the screen in FIG. 5 or FIG. 7) (S3). In step S3, if it is determined that the display does not change to the urgent operation screen (NO in S3), operation panel control unit 156 repeats the process in step S3.

In step S3, if it is determined that the display changes to the urgent operation screen (YES in S3), operation panel control unit 156 performs a process of monitoring a runaway of touch panel control microcomputer 103, based on a signal from touch panel IF 106 (S5). Subsequently, operation panel control unit 156 determines whether touch panel control microcomputer 103 runs away while LCD screen 101 is displaying the urgent operation screen (S7). In step S7, if it is determined that touch panel control microcomputer 103 does not run away (NO in S7), operation panel control unit 156 repeats the process in step S7.

In step S7, if it is determined that touch panel control microcomputer 103 runs away (YES in S7), operation panel control unit 156 allocates the operation (the functions of “delete,” “priority output,” and “clear accumulation” keys 301 to 303) accepted by the software key on LCD screen 101, to hardware key 104 (keys 181 to 183) in the vicinity of LCD screen 101 (S9). Then, operation panel control unit 156 executes allocation guidance (S11). In step S11, operation panel control unit 156 performs display 311 to 313 to indicate that the respective functions of keys 301 to 303 are allocated to keys 181 to 183, respectively. In addition, operation panel control unit 156 displays message M1 or M2 “execution key is now changed” on LCD screen 101 and allows alert LED or buzzer 105 to produce LED alert display or beep sound. Then, operation panel control unit 156 executes a reset process and an initialization process of touch panel control microcomputer 103 (S13). After completion of these processes, operation panel control unit 156 clears the operation allocated to hardware key 104 (S15). Then, operation panel control unit 156 executes clearance guidance (S17). In step S17, operation panel control unit 156 terminates the allocation to hardware key 104 so that operation can be accepted by the software key in the original LCD screen 101, and erases display 311 to 313 from LCD screen 101. Operation panel control unit 156 allows alert LED or buzzer 105 to produce LED alert display or beep sound. Operation panel control unit 156 thereafter proceeds to the process in step S1 and continues display control of LCD screen 101.

### Second Embodiment

In the present embodiment, the operation of operation panel control unit 156 at a time when touch panel control microcomputer 103 runs away will be described in a case where LCD screen 101 displays a screen showing a job in progress. The configuration of the digital color MFP in the present embodiment is similar to the configuration in the first embodiment, and therefore, a description thereof will not be repeated.

Operation panel 100 in the present embodiment does not include the hardware keys corresponding to the start key (key 184 in FIG. 5) pressed to execute a variety of jobs and the stop key (key 185 in FIG. 5) pressed to stop a job in progress. The start key and the stop key are displayed as software keys on LCD screen 101 in a prescribed case. When the start key or the stop key displayed on LCD screen 101 is pressed by the user, the digital color MFP executes or stops the job.

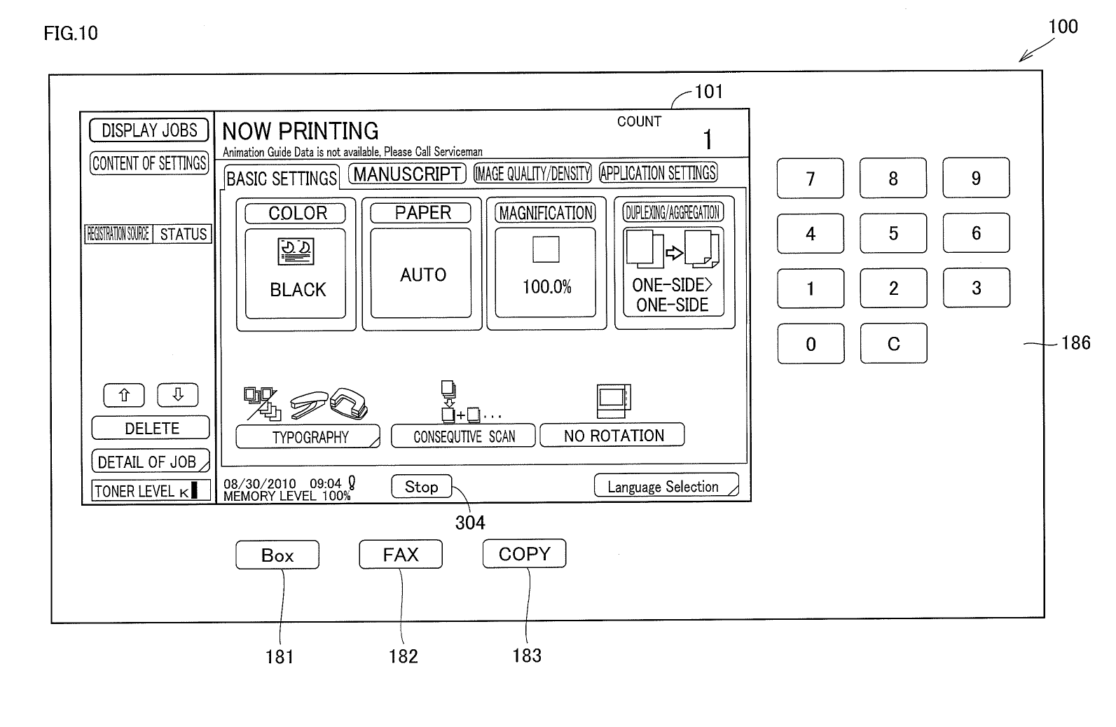

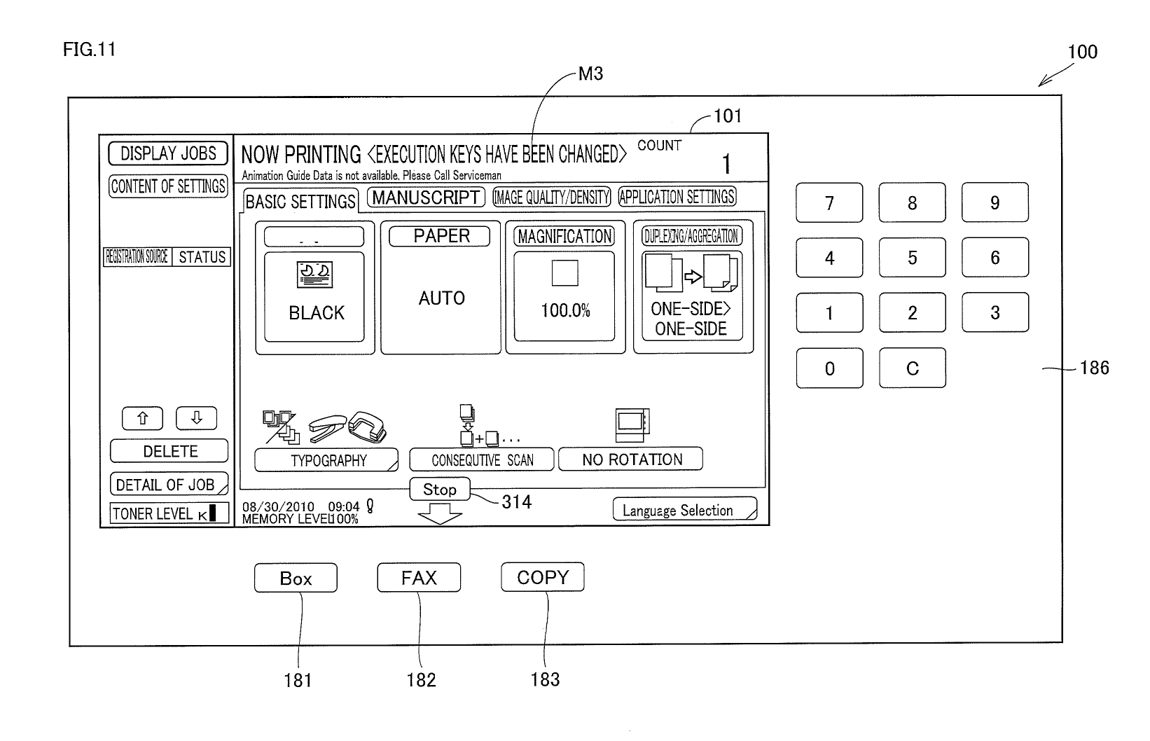

FIG. 10 is a diagram showing a state in which a screen showing a copy job in progress appears on LCD screen 101.

Referring to FIG. 10, when the start key (not shown) displayed on LCD screen 101 is pressed by the user and the digital color MFP starts executing a copy job, operation panel control unit 156 displays a screen showing a copy job in progress on LCD screen 101. LCD screen 101 displays a message, for example, “copying” and a key 304 serving as a stop key. Then, upon completion of the copy job, operation panel control unit 156 displays a screen showing job waiting (normal state) on LCD screen 101. LCD screen 101 displays a message “ready to copy” instead of the message “copying” and further displays a start key (not shown), for example, at the position of key 304 as a stop key.

In a case where touch panel control microcomputer 103 runs away in the state in which the screen showing a copy job in progress appears on LCD screen 101, the user cannot perform operation for stopping the job using the software key when necessary. As a result, unnecessary printout of the copy job that the user does not want may be continued. In order to prevent such a situation, in the present embodiment, in a case where a runaway of touch panel control microcomputer 103 is detected, operation panel control unit 156 allocates, to hardware key 104, the operation for stopping the job that is accepted by the software key in LCD screen 101 (touch panel TP) at the time of detection of the runaway.

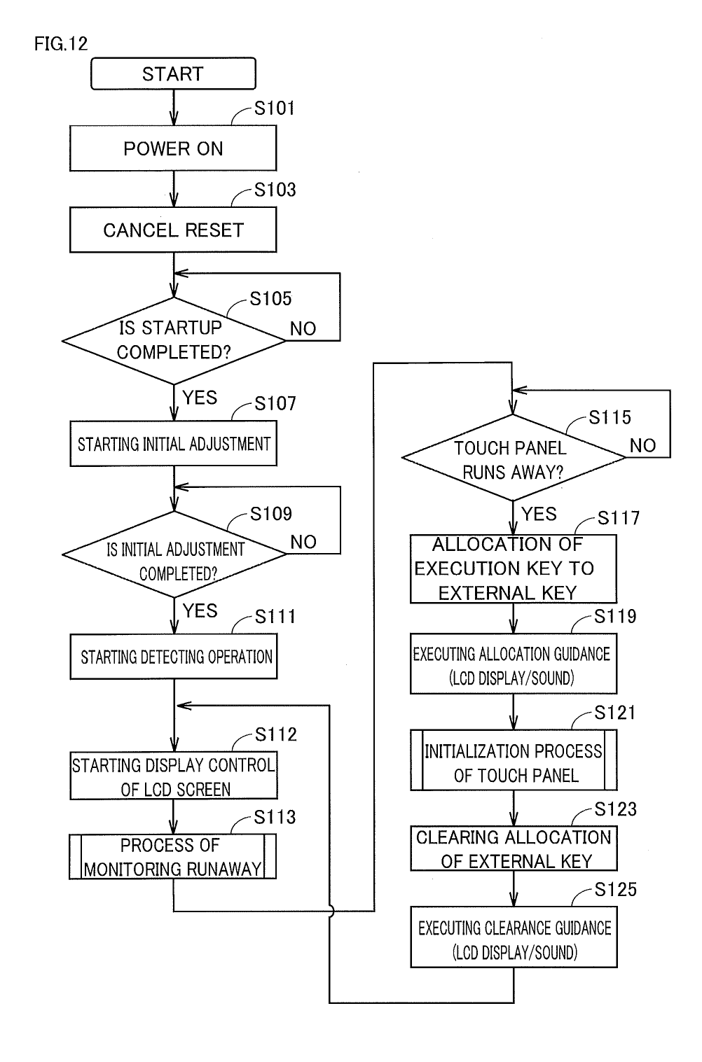

FIG. 11 is a diagram schematically showing screen display of operation panel 100 in the case where touch panel control microcomputer 103 runs away in a state in which the screen showing a copy job in progress appears on LCD screen 101.

Referring to FIG. 11, specifically, the function of key 304 is allocated to key 182 below LCD screen 101 in the vicinity thereof. Display 314 is performed on LCD screen 101 to give a notification that the function of key 304 is allocated to key 182. Display 314 does not accept being pressed by the user per se. Key 304, which has been displayed on the screen showing a copy job in progress (FIG. 10), is deleted from LCD screen 101. A message M3, for example, “execution key is now changed” appears on LCD screen 101 in order to notify the user of the change from the software key to hardware key 104.

After the reset process and the initialization process of touch panel control microcomputer 103 are completed and operation with touch panel TP becomes possible, operation panel control unit 156 terminates the allocation of operation to hardware key 104 and performs a process for returning display on LCD screen 101 to the screen showing a copy job in progress (FIG. 10).

In a case where operation panel control unit 156 detects a runaway of touch panel control microcomputer 103 and allocates operation to hardware key 104 (when the screen in FIG. 10 is switched to the one in FIG. 11), operation panel control unit 156 may allow alert LED or buzzer 105 to produce LED alert display or beep sound. When the allocation of operation to hardware key 104 is terminated (the screen in FIG. 11 is switched to the one in FIG. 10), operation panel control unit 156 may allow alert LED or buzzer 105 to produce LED alert display or beep sound.

In a case where touch panel control microcomputer 103 runs away in a normal state in which job waiting is displayed, the start key may he allocated to a hardware key, similarly, in order to accept execution of a job that the user wants to execute urgently.

FIG. 12 is a flowchart of control performed by operation panel control unit 156 in the second embodiment of the present invention.

Referring to FIG. 12, when operation panel control unit 156 (touch panel TP) is powered on (S101), operation panel control unit 156 cancels the reset of touch panel control microcomputer 103 and touch panel sensor unit 102 (sensor IC contained in touch panel TP) (S103) and determines whether the startup of touch panel control microcomputer 103 and touch panel sensor unit 102 is completed, for example, through a serial interface such as an I2C bus (S105). In step S105, if it is determined that the startup is not completed (NO in S105), operation panel control unit 156 repeats the process in step S105.

In step S105, if it is determined that the startup is completed (YES in S105), operation panel control unit 156 issues an initial adjustment command for sensitivity adjustment of touch panel TP to touch panel control microcomputer 103 and starts initial adjustment (initialization process) of touch panel control microcomputer 103 (S107). Then, operation panel control unit 156 determines whether initial adjustment is completed (S109). In step S109, if it is determined that initial adjustment is not completed (NO in S109), operation panel control unit 156 repeats the process in step S109.

In step S109, if it is determined that initial adjustment is completed (YES in S109), operation panel control unit 156 starts an operation to detect touch operation on touch panel TP (S111) and starts display control of LCD screen 101 (S112). Then, operation panel control unit 156 performs a process of monitoring a runaway of touch panel control microcomputer 103, based on a signal from touch panel IF 106 (S113). Then, operation panel control unit 156 determines whether touch panel control microcomputer 103 runs away (S115). In step S115, if it is determined that touch panel control microcomputer 103 does not runaway (NO in S115), operation panel control unit 156 repeats the process in step S115.

In step S115, if it is determined that touch panel control microcomputer 103 runs away (YES in S115), operation panel control unit 156 allocates the operation accepted by the software on LCD screen 101 (the function of key 304) to hardware key 104 (key 182) in the vicinity of LCD screen 101 (S117). Then, operation panel control unit 156 executes allocation guidance (S119). In step S119, operation panel control unit 156 performs display 314 to indicate that the function of key 304 is allocated to key 182. In addition, operation panel control unit 156 displays message M3, for example, “execution key is now changed” on LCD screen 101 and allows alert LED or buzzer 105 to produce LED alert display or beep sound. Then, operation panel control unit 156 executes a reset process and an initialization process of touch panel control microcomputer 103 (S121). After completion of these processes, operation panel control unit 156 clears the operation allocated to hardware key 104 (S123). Then, operation panel control unit 156 executes clearance guidance (S125). In step S125, operation panel control unit 156 terminates the allocation to hardware key 104 so that operation can be accepted by the software key in the original LCD screen 101, and erases display 314 from LCD screen 101. Operation panel control unit 156 also allows alert LED or buzzer 105 to produce LED alert display or beep sound. Operation panel control unit 156 thereafter proceeds to the process in step S112 and continues display control of LCD screen 101.

### Effects of Embodiments

According to the foregoing embodiments, an operation panel with improved convenience for users can be provided.

According to the foregoing embodiments, when the touch panel control microcomputer (CPU for touch panels) runs away due to electrostatic discharge (electrostatic noise), the operation accepted by the touch panel is allocated to a hardware key, so that the operation input to the digital color MFP can be continued. This prevents the user from being unable to perform touch panel operation. In particular, even when urgent operation of the digital color MFP is required, it is possible to prevent the user from being unable to continue the operation.

In the case where the touch panel control microcomputer runs away, when a job list is being displayed, keys for performing operations of “delete,” “priority output,” and “cancel accumulation” for a job are allocated to hardware keys in the vicinity of the LCD screen, thereby allowing the user to perform these operations.

In the case where the touch panel control microcomputer runs away, when a confidential fax is being received, or there exists data already received of a confidential fax, or there exists a reserved received job of a confidential fax, a confidential job print instruction key, a job discard key, and the like are allocated to hardware keys in the vicinity of the LCD screen, thereby allowing the user to continue operation of a job concerning a confidential fax.

In the case where the touch panel control microcomputer runs away, when the digital color MFP is executing a job, a key to stop a job is allocated to a hardware key in the vicinity of the LCD screen, thereby allowing the user to perform operation for stopping the job.

Beep sound is produced when operation is allocated to a hardware key, so that the user is notified of a runaway of the touch panel.

Beep sound is also produced when allocation of operation to a hardware key is terminated, so that the user is notified that the touch panel recovers from the runaway.

### [Others]

In the second embodiment, the touch panel control microcomputer runs away during execution of a copy job. The operation panel control unit may perform similar control in the case where the touch panel control microcomputer runs away during execution of a job other than a copy job.

The foregoing embodiments can be combined as appropriate. For example, the first embodiment may be combined with the second embodiment. In this case, allocation to a hardware key may be performed when the touch panel control microcomputer runs away in a slate in which a list of jobs registered in the digital color MFP appears on the LCD screen, in a state in which a reception list of confidential faxes appears on the LCD screen, or in a state in which a screen showing a job in progress appears on the LCD screen.

In the foregoing embodiments, in the case where the LCD screens displays the urgent operation screen as shown in FIG. 5 or FIG. 7 or the screen showing a job in progress as shown in FIG. 10, when the touch panel control microcomputer runs away, the operation accepted by a software key on the LCD screen is allocated to a hardware key. However, in the present invention, a display state of the display unit at the time of detection of a runaway is not limited as long as the operation accepted by the touch panel at the time of detection of a runaway is allocated to a hardware key in a case where a runaway is detected.

The process in the foregoing embodiments may be performed by software or may be performed using a hardware circuit. A program for executing the process in the foregoing embodiments may be provided. A recording medium encoded with the program, such as a CD-ROM, a flexible disk, a hard disk, a ROM, a RAM, or a memory card, may be provided to users. The program is executed by a computer such as a CPU. The program may be downloaded to a device through a communication line such as the Internet.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An operation panel comprising:
a display unit;
a touch panel for accepting touch input to said display unit concerning operation;
a hardware key;
a touch panel control unit for detecting a position of touch input accepted by said touch panel;
a runaway detection unit for detecting a runaway which is a state in which said touch panel control unit cannot detect a position of touch input; and
an allocation unit for allocating operation accepted by said touch panel to said hardware key when a runaway is detected by said runaway detection unit.

2. The operation panel according to claim 1, further comprising a notification unit for performing display on said display unit to indicate operation allocated to said hardware key when a runaway is detected by said runaway detection unit.

3. The operation panel according to claim 1, wherein in at least one of cases where a received job of a confidential fax is being executed, where there exists data already received in a received job of a confidential fax, and in where there exists a reserved received job of a confidential fax, when a runaway is detected by said runaway detection unit, said allocation unit allocates, to said hardware key, a key for giving an instruction to output data related to the received job or a key for giving an instruction to discard the received job.

4. The operation panel according to claim 1, wherein in a case where said touch panel is accepting touch input related to a next operation, when a runaway is detected by said runaway detection unit, said allocation unit allocates a key for performing the next operation to said hardware key.

5. The operation panel according to claim 1, further comprising a first alert producing unit for producing an alert with at least one of light and sound when said allocation unit allocates operation.

6. The operation panel according to claim 1, further comprising an initialization unit for initializing said touch panel control unit when a runaway is detected by said runaway detection unit,
wherein said allocation unit terminates allocation of operation after initialization by said initialization unit is completed.

7. The operation panel according to claim 6, further comprising a second alert producing unit for producing an alert with at least one of light and sound when said allocation unit terminates allocation of operation.

8. A method of controlling an operation panel including a display unit, a touch panel for accepting touch input to said display unit concerning operation, a hardware key, and a touch panel control unit for detecting a position of touch input accepted by said touch panel, comprising the steps of:
detecting a runaway which is a state in which said touch panel control unit cannot detect a position of touch input; and
allocating operation accepted by said touch panel to said hardware key when a runaway is detected in said step of detecting.

9. The method according to claim 8, further comprising a notification step of performing display on said display unit to indicate operation allocated to said hardware key when a runaway is detected in said step of detecting.

10. The method according to claim 8, wherein in at least one of cases where a received job of a confidential fax is being executed, where there exists data already received in a received job of a confidential fax, and where there exists a reserved received job of a confidential fax, when a runaway is detected in said step of detecting, a key for giving an instruction to output data related to the received job or a key for giving an instruction to discard the received job is allocated to said hardware key in said step of allocating.

11. The method according to claim 8, wherein in a case where said touch panel is accepting touch input related to a next operation, when a runaway is detected in said step of detecting, a key for performing the next operation is allocated to said hardware key in said step of allocating.

12. The method according to claim 8, further comprising a first alert producing step of producing an alert with at least one of light and sound when operation is allocated in said step of allocating.

13. The method according to claim 8, further comprising the step of initializing said touch panel control unit when a runaway is detected in said step of detecting,
wherein allocation of operation is terminated in said step of allocating, after initialization in said step of initializing is completed.

14. The method according to claim 13, further comprising a second alert producing step of producing an alert with at least one of light and sound when allocation of operation is terminated in said step of allocating.

15. A non-transitory computer-readable medium storing a control program of an operation panel,
said operation panel including a display unit, a touch panel for accepting touch input to said display unit concerning operation, a hardware key, and a touch panel control unit for detecting a position of touch input accepted by said touch panel,
the control program causing a computer to execute processing comprising the steps of:
detecting a runaway which is a state in which said touch panel control unit cannot detect a position of touch input; and
allocating operation accepted by said touch panel to said hardware key when a runaway is detected in said step of detecting.

16. The recording medium according to claim 15, wherein the control program further causes a computer to execute a notification step of performing display on said display unit to indicate operation allocated to said hardware key when a runaway is detected in said step of detecting.

17. The recording medium according to claim 15, wherein in at least one of cases where a received job of a confidential fax is being executed, where there exists data already received in a received job of a confidential fax, and where there exists a reserved received job of a confidential fax, when a runaway is detected in said step of detecting, a key for giving an instruction to output data related to the received job or a key for giving an instruction to discard the received job is allocated to said hardware key in said step of allocating.

18. The recording medium according to claim 15, wherein in a case where said touch panel is accepting touch input related to a next operation, when a runaway is detected in said step of detecting, a key for performing the next operation is allocated to said hardware key in said step of allocating.

19. The recording medium according to claim 15, wherein the control program of said operation panel further causes a computer to execute a first alert producing step of producing an alert with at least one of light and sound when operation is allocated in said step of allocating.

20. The recording medium according to claim 15, wherein
the control program of said operation panel further causes a computer to execute the step of initializing said touch panel control unit when a runaway is detected in said step of detecting, and
allocation of operation is terminated in said step of allocating, after initialization in said step of initializing is completed.

21. The recording medium according to claim 20, wherein the control program of said operation panel further causes a computer to execute a second alert producing step of producing an alert with at least one of light and sound when allocation of operation is terminated in said step of allocating.
